(19) United States
(12) Patent Application Publication
(10) Pub. No.: US 2025/0344041 A1
(43) Pub. Date: Nov. 6, 2025

(54) METHOD AND APPARATUS FOR SIDELINK POSITIONING IN MOBILE COMMUNICATIONS

(71) Applicant: MediaTek Singapore Pte. Ltd., Singapore (SG)

(72) Inventors: Guillaume SEBIRE, Oulu (FI); Nathan Edward TENNY, San Jose, CA (US)

(21) Appl. No.: 18/868,914

(22) PCT Filed: Jun. 6, 2023
(86) PCT No.: PCT/US2023/067959

§ 371 Date: Nov. 25, 2024

Related U.S. Application Data
(60) Provisional application No. 63/367,658, filed on Jul. 5, 2022.

(51) Int. Cl. H04W 4/029

(52) U.S. Cl. CPC H04W 4/029

(57) ABSTRACT

Examples pertaining to sidelink positioning in mobile communications are described. In one example, an apparatus operating as a target user equipment (UE) determines whether the target UE requires support from one location server UE during a sidelink location request (LR) procedure. The apparatus selects a location server UE in a case that the target UE requires support from one location server UE. The apparatus performs UE positioning to determine a location of the target UE with or without support of the selected location server UE. In another example, an apparatus operating as a location server UE performs a location server UE selection with a target UE or a location services (LCS) client during a sidelink LR procedure. The apparatus performs UE positioning to determine a location of the target UE in a case that the target UE requires support from one location server UE.

### CROSS REFERENCE TO RELATED PATENT APPLICATION(S)

The present disclosure is part of a non-provisional application claiming the priority benefit of U.S. Provisional Patent Application No. 63/367,658, filed 5 Jul. 2022, the content of which herein being incorporated by reference in its entirety.

### TECHNICAL FIELD

The present disclosure is generally related to mobile communications and, more particularly, to sidelink positioning in mobile communications.

### BACKGROUND

Unless otherwise indicated herein, approaches described in this section are not prior art to the claims listed below and are not admitted as prior art by inclusion in this section.

Cellular based vehicle-to-everything (V2X) (e.g., long-term evolution (LTE) V2X or new radio (NR) V2X) is a radio access technology developed by the 3^{rd} generation partnership project (3GPP) to support advanced vehicular applications. In V2X, a direct radio link (also called a sidelink) may be established between two user equipment (UEs) (e.g., mounted on vehicles). The sidelink may operate under the control of a cellular network (e.g., for radio resource allocation) when the UEs are within the coverage of the cellular network. Alternatively, the sidelink may operate independently, e.g., when no cellular network is present or reachable. In particular, sidelink communication is performed via a direct communication interface called PC5 interface.

In wireless communications, such as mobile communications under the 3^{rd} generation partnership project (3GPP) standards including 5^{th} generation (5G) new radio (NR) and 4^{th} generation (4G) long-term evolution (LTE), user equipment (UE) positioning requires network involvement to estimate the location of a UE. The current framework for positioning in 5G NR generally requires network entities, including access and mobility management function (AMF), location management function (LMF), gateway mobile location center (GMLC), and unified data management (UDM), to interact with each other, the target UE, and the location services (LCS) client in the positioning operations. However, in peer-to-peer scenarios, there will be no network involvement in sidelink positioning, especially given the situation that no cellular network is present or reachable. Therefore, there is a need to provide a signaling framework for sidelink positioning in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to sidelink positioning in mobile communications. It is believed that the above-described issue would be avoided or otherwise alleviated by implementing one or more of the proposed schemes described herein.

In one aspect, a method may involve a processor of an apparatus, operating as a target user equipment (UE), determining whether the target UE requires support from one location server UE during a sidelink location request (LR) procedure. The method may also involve the processor selecting a location server UE in a case that the target UE requires support from one location server UE. The method may further involve the processor performing UE positioning to determine a location of the target UE with or without support of the selected location server UE.

In another aspect, a method may involve a processor of an apparatus, operating as a location server UE, performing a location server UE selection with a target UE or a location services (LCS) client during a sidelink LR procedure. The method may also involve the processor performing UE positioning to determine a location of the target UE in a case that the target UE requires support from one location server UE.

In yet another aspect, an apparatus may include a transceiver which, during operation, wirelessly communicates with one or more UEs. The apparatus may also include a processor communicatively coupled to the transceiver. The processor, during operation, may perform operations including determining whether the target UE requires support from one location server UE during a sidelink LR procedure. The processor may also perform operations including selecting, via the transceiver, a location server UE in a case that the target UE requires support from one location server UE. The processor may further perform operations including performing, via the transceiver, UE positioning to determine a location of the target UE with or without support of the selected location server UE.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an exemplary message sequence chart of a Case-I signaling framework for a PC5 mobile-terminated (MT) location request (LR) procedure under schemes in accordance with implementations of the present disclosure.

FIG. 2 is a diagram depicting an exemplary message sequence chart of a Case-I signaling framework for a PC5 mobile-originated (MO) LR procedure under schemes in accordance with implementations of the present disclosure.

FIG. 3 is a diagram depicting an exemplary message sequence chart of a Case-II signaling framework for a PC5 MT LR procedure under schemes in accordance with implementations of the present disclosure.

FIG. 4 is a diagram depicting an exemplary message sequence chart of a Case-II signaling framework for a PC5 MO LR procedure under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sidelink positioning in mobile communications, or specifically speaking peer-to-peer sidelink positioning in mobile communications. According to the present disclosure, a number of possible solutions may be implemented separately or jointly. That is, although these possible solutions may be described below separately, two or more of these possible solutions may be implemented in one combination or another.

The current framework for positioning in 5^{th} generation (5G) new radio (NR) generally requires network entities, including access and mobility management function (AMF), location management function (LMF), gateway mobile location center (GMLC), and unified data management (UDM), to interact with each other, the target UE, and the location services (LCS) client in the positioning operations. For example, it is the GMLC (with assistance from the UDM) that is responsible for authorizing the LCS clients or Application Function (AF) and ensuring the privacy of a target UE is respected. However, in peer-to-peer scenarios, there will be no network involvement in sidelink positioning, especially given the situation that no cellular network is present or reachable. Therefore, there is a need to provide a signaling framework for sidelink positioning in mobile communications.

In view of the above, the present disclosure proposes a number of schemes pertaining to sidelink positioning in mobile communications. According to the schemes of the present disclosure, no distinct “GMLC/UDM UE” is introduced, and instead, necessary functionalities are hosted either in the target UE or the location server UE. The target UE may store its own LCS privacy profile (SLPP) information. The target UE may interact directly with the location server UE. Specifically, the case that necessary functionalities for sidelink positioning are hosted in the target UE is referred to herein as Case-I signaling framework, while the case that necessary functionalities for sidelink positioning are hosted in the location server UE is referred to herein as Case-II signaling framework.

In Case-I signaling framework, the target UE hosts GMLC-like functionality (e.g., the target UE interacts directly with the LCS client). The target UE itself vets any incoming location requests addressed to it and only responds to requests it successfully vets, such that illicit requests do not cause undue signaling. It is noteworthy that, in network-based scenarios, an LCS client is verified to be authorized, or not, to retrieve the UE location, as a function of the subscriber LCS privacy profile (SLPP) that is stored as part of the subscription data in the UDM, and LCS client data (e.g., location request type, client identity, etc.). The SLPP is subscriber-specific and may be updated by the UE, e.g., depending on user input. By contrast, in peer-to-peer scenarios, it may therefore be expected that the target UE itself holds its own SLPP information, and using this information and the LCS client data, such as location request type (e.g., positioning or ranging), accuracy, and client identity, etc., is able to determine whether or not to authorize the LCS client to retrieve its location. Furthermore, without an AMF, the target UE needs to take on the role of the AMF. In particular, the target UE itself may select and interact with the location server UE, if the target UE determines that it needs assistance/support from one location server UE for positioning of the target UE.

In Case-II signaling framework, the location server UE hosts GMLC/UDM-like functionality. The location server UE interacts with the LCS client, i.e., it acts as a “proxy” between the LCS client and the target UE. Unlike Case-I signaling framework, the target UE does not interact directly with the LCS client in this case. However, like Case-I signaling framework, it may be expected here as well that the target UE itself holds its own SLPP information which may be queried/used by the location server UE when interacting with the LCS client. The location server UE may be able to store the SLPP information of the target UE. Furthermore, the LCS client needs to select a location server UE (with GMLC/UDM-like functionality) in order for the LCS client to be able to issue a location service request.

Accordingly, by applying the schemes of the present disclosure, sidelink positioning (and ranging) may be achieved between UEs only, with simplified and efficient signaling frameworks that do not introduce a distinct “GMLC/UDM UE”.

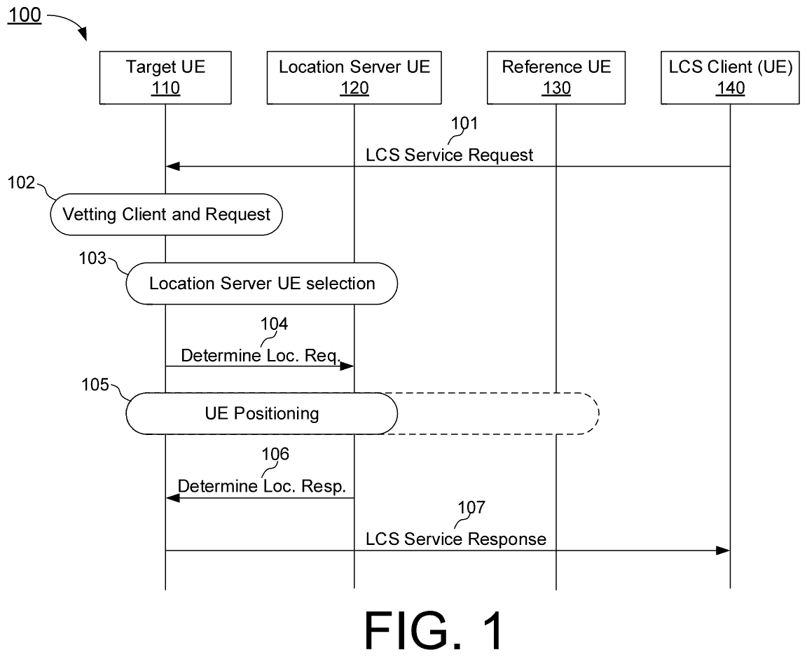

FIG. 1 illustrates an example scenario 100 under schemes in accordance with implementations of the present disclosure. Scenario 100 involves a target UE 110 (with GMLC-like functionality), a location server UE 120, a reference UE 130, and an LCS client 140. Scenario 100 illustrates an exemplary message sequence chart of a Case-I signaling framework for a PC5 mobile-terminated (MT) location request (LR) procedure. In step 101, the LCS client 140 (e.g., in a UE) needs to retrieve the location information of the target UE 110, and accordingly, the LCS client 140 issues/transmits an LCS Service Request message over the PC5 interface to the target UE 110 in order to retrieve the location of the target UE 110. The LCS Service Request message contains LCS client data, including the LCS client identity, the type of location request (e.g., positioning/ranging), the accuracy of the location, etc., that allows the target UE 110 to identify the LCS client 140. In step 102, upon reception of the LCS Service Request message, the target UE 110 verifies/determines whether the originating LCS client 140 and its location request are authorized. The target UE may use its own stored SLPP information and the identified LCS client data in the LCS Service Request message to determine whether or not to authorize the LCS client 140 and its location request. If the target UE 110 determines that the LCS client 140 and its location request are not authorized, the target UE 110 does not respond to the LCS Service Request message, and the procedure stops or ends. Otherwise, if the target UE 110 determines that the LCS client 140 and its location request are authorized, the procedure proceeds to step 103.

In step 103, the target UE 110 determines whether it requires support from one location server UE, and if so, the target UE 110 selects a location server UE. Otherwise, if the target UE 110 determines that it does not need support from one location server UE, the procedure proceeds to step 105. The selection of a location server UE by the target UE 110 is performed using direct discovery. To facilitate direct discovery, either model A discovery or model B discovery may be used as follows (please refer to 3GPP technical specification (TS) 23.303 for definitions of models A and B discovery). With model A discovery, the location server UE 120 (or called an announcing UE) announces itself at least as a location server UE, and the target UE 110 (or called a monitoring UE) monitors such announcement. With model B discovery, the target UE 110 (or called a discoverer UE) issues requests including information that it wishes to discover a location server UE (or called a discoveree UE). Once a location server UE is selected, direct communication is established between the target UE 110 and the selected location server UE 120, allowing the procedure to proceed to step 104.

In step 104, the target UE 110 issues/transmits a Determine Location Request message to the selected location server UE 120, if the target UE 110 requires support from one location server UE. The Determine Location Request message contains necessary information as required by the LCS Client in step 101. Otherwise, if the target UE 110 does not require support from one location server UE, this step may be skipped.

In step 105, the UE positioning (and/or ranging) is performed by the target UE 110 alone or with support of the selected location server UE 120, depending on the outcome of step 103, in order to determine the location of the target UE 110. It is noteworthy that, if necessary, a reference UE 130 (or more reference UEs) may also be invoked at this point to assist the target UE 110 or the location server UE 120 in determining the location of the target UE 110.

In step 106, if a Determine Location Request message is received earlier, the location server UE 120 reports the calculated location information of the target UE 110 in a Determine Location Response message to the target UE 110.

In step 107, the target UE 110 reports its location information in an LCS Service Response message to the LCS client 140.

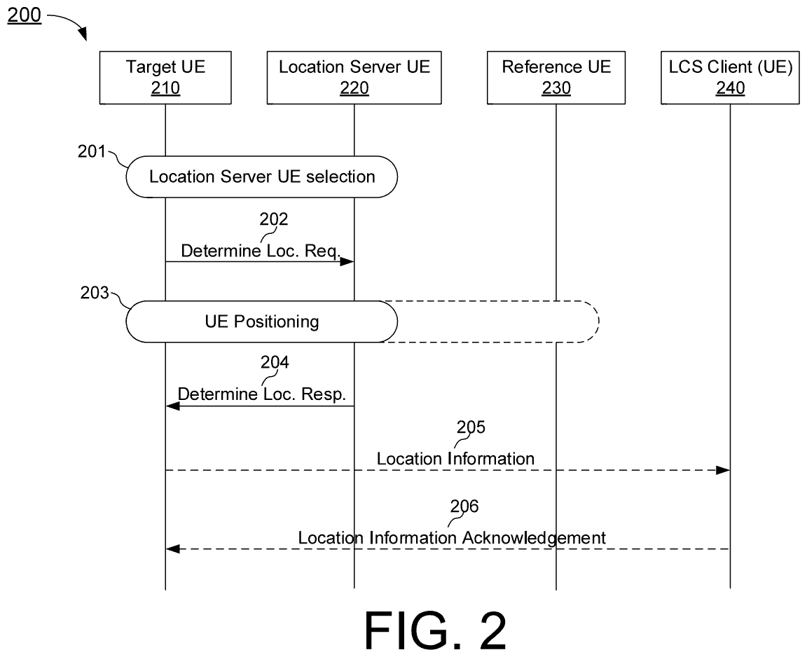

FIG. 2 illustrates an example scenario 200 under schemes in accordance with implementations of the present disclosure. Scenario 200 involves a target UE 210 (with GMLC-like functionality), a location server UE 220, a reference UE 230, and an LCS client 240. Scenario 200 illustrates an exemplary message sequence chart of a Case-I signaling framework for a PC5 mobile-originated (MO) LR procedure. In step 201, the target UE 210 determines whether it requires support from one location server UE, and if so, the target UE 210 selects a location server UE. Otherwise, if the target UE 210 determines that it does not need support from one location server UE, the procedure proceeds to step 203. The selection of a location server UE by the target UE 210 is performed using direct discovery. To facilitate direct discovery, either model A discovery or model B discovery may be used as follows (please refer to 3GPP TS 23.303 for definitions of models A and B discovery). With model A discovery, the location server UE 220 (or called an announcing UE) announces itself at least as a location server UE, and the target UE 210 (or called a monitoring UE) monitors such announcement. With model B discovery, the target UE 210 (or called a discoverer UE) issues requests including information that it wishes to discover a location server UE (or called a discoveree UE). Once a location server UE is selected, direct communication is established between the target UE 210 and the selected location server UE 220, allowing the procedure to proceed to step 202.

In step 202, the target UE 210 issues/transmits a Determine Location Request message to the selected location server UE 220, if the target UE 210 requires support from one location server UE. The Determine Location Request message contains necessary information as required by the intended location operation. Otherwise, if the target UE 210 does not require support from one location server UE, this step may be skipped.

In step 203, the UE positioning (and/or ranging) is performed by the target UE 210 alone or with support of the selected location server UE 220, depending on the outcome of step 201, in order to determine the location of the target UE 210. It is noteworthy that, if necessary, a reference UE 230 (or more reference UEs) may also be invoked at this point to assist the target UE 210 or the location server UE 220 in determining the location of the target UE 210.

In step 204, if a Determine Location Request message is received earlier, the location server UE 220 responds to the Determine Location Request message with a Determine Location Response message to the target UE 210. The Determine Location Response message contains information indicating the calculated location of the target UE 210.

In step 205, the target UE 210 reports its location information to an authorized LCS client 240, if reporting to an LCS client is necessary as required by the intended location operation. Otherwise, if reporting to an LCS client is not necessary, this step may be skipped.

In step 206, the LCS client 240 replies with an acknowledgement of receipt of the location information from the target UE 210.

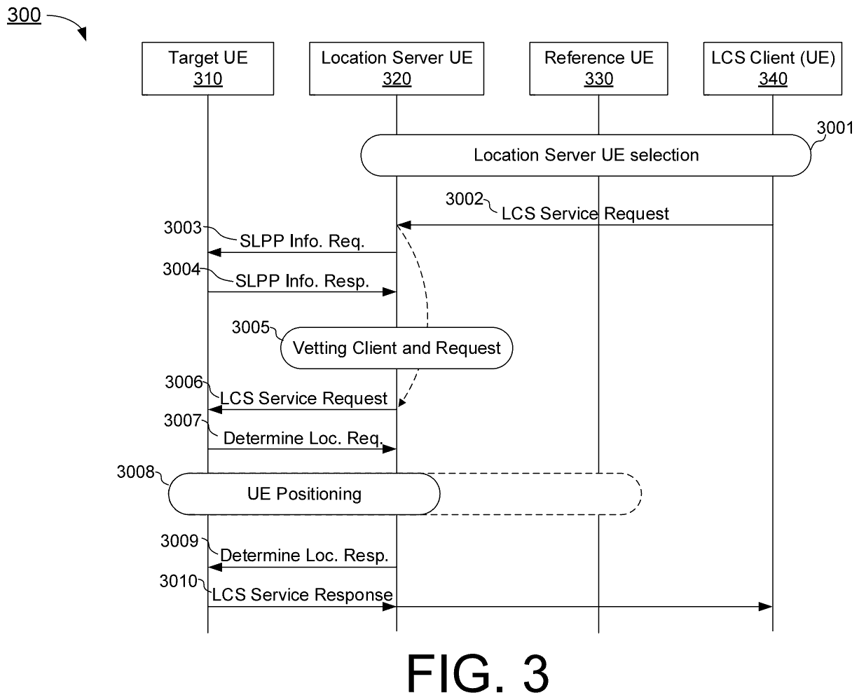

FIG. 3 illustrates an example scenario 300 under schemes in accordance with implementations of the present disclosure. Scenario 300 involves a target UE 310, a location server UE 320 (with GMLC/UDM-like functionality), a reference UE 330, and an LCS client 340. Scenario 300 illustrates an exemplary message sequence chart of a Case-II signaling framework for a PC5 MT LR procedure. In step 3001, the LCS client 340 (e.g., in a UE) needs to retrieve the location information of the target UE 310, and accordingly, the LCS client UE 340 selects a location server UE (with GMLC/UDM-like functionality). The selection of a location server UE may be performed using direct discovery by both the LCS client UE 340 and the location server UE 320. To facilitate direct discovery, either model A discovery or model B discovery may be used as follows (please refer to 3GPP TS 23.303 for definitions of models A and B discovery). With model A discovery, the location server UE 320 (or called an announcing UE) announces itself at least as a location server UE, and the LCS client UE 340 (or called a monitoring UE) monitors such announcement. With model B discovery, the LCS client UE 340 (or called a discoverer UE) issues requests including information that it wishes to discover a location server UE (or called a discoveree UE). Once a location server UE is selected, direct communication is established between the LCS client UE 340 and the selected location server UE 320, allowing the procedure to proceed to step 3002.

In step 3002, the LCS client 340 issues/transmits an LCS Service Request message over the PC5 interface to the location server UE 320 in order to retrieve the location of the target UE 310. The LCS Service Request message contains LCS client data, including the LCS client identity, the type of location request (e.g., positioning/ranging), the accuracy of the location, etc., that allows the location server UE 320 to identify the LCS client 340, and contains information that allows the location server UE 320 to identify the target UE 310. If the location server UE 320 holds/stores the SLPP information of the target UE 310, the procedure proceeds to step 3005. Otherwise, if the location server UE 320 does not hold/store the SLPP information of the target UE 310, the procedure proceeds to step 3003.

In step 3003, after discovering the target UE 310 and establishing direct communication with the target UE 310, the location server UE 320 issues/transmits an SLPP Information Request message to the target UE 310 to retrieve its SLPP Information.

In step 3004, upon receiving the SLPP Information Request message, the target UE 310 replies with an SLPP Information Response message including the SLPP information of the target UE 310.

In step 3005, the location server UE 320 verifies/determines whether the originating LCS client 340 and its location request are authorized. The location server UE 320 uses the SLPP information of the target UE 310 and the identified LCS client data in the LCS Service Request message to determine whether or not to authorize the LCS client 340 and its location request. If the location server UE 320 determines that the LCS client and its location request are not authorized, the location server UE 320 may reject the location request from the LCS client 340 (e.g., by not responding to the LCS Service Request message and the procedure stops or ends). Otherwise, if the location server UE 320 determines that the LCS client and its location request are authorized, the procedure proceeds to step 3006.

In step 3006, the location server UE 320 forwards the authorized LCS Service Request to the target UE 310. If the target UE 310 determines that it requires support from one location server UE to determine its location, the procedure proceeds to step 3007. Otherwise, if the target UE 310 determines that it does not require support from one location server UE to determine its location, the procedure proceeds to step 3008.

In step 3007, the target UE 310 issues/transmits a Determine Location Request message to the location server UE 320. The Determine Location Request message contains necessary information as required by the LCS client 340 in step 3001.

In step 3008, the UE positioning (and/or ranging) is performed by the target UE 310 alone or with support of the location server UE 320, depending on the outcome of step 3006, in order to determine the location of the target UE 310. It is noteworthy that, if necessary, a reference UE 330 (or more reference UEs) may also be invoked at this point to assist the target UE 310 or the location server UE 320 in determining the location of the target UE 310.

In step 3009, if a Determine Location Request message is received earlier, the location server UE 320 reports the calculated location information of the target UE 310 in a Determine Location Response message to the target UE 310.

In step 3010, the target UE 310 reports its location information in an LCS Service Response message to the location server UE 320 which in turn forwards the LCS Service Response message to the LCS client 340.

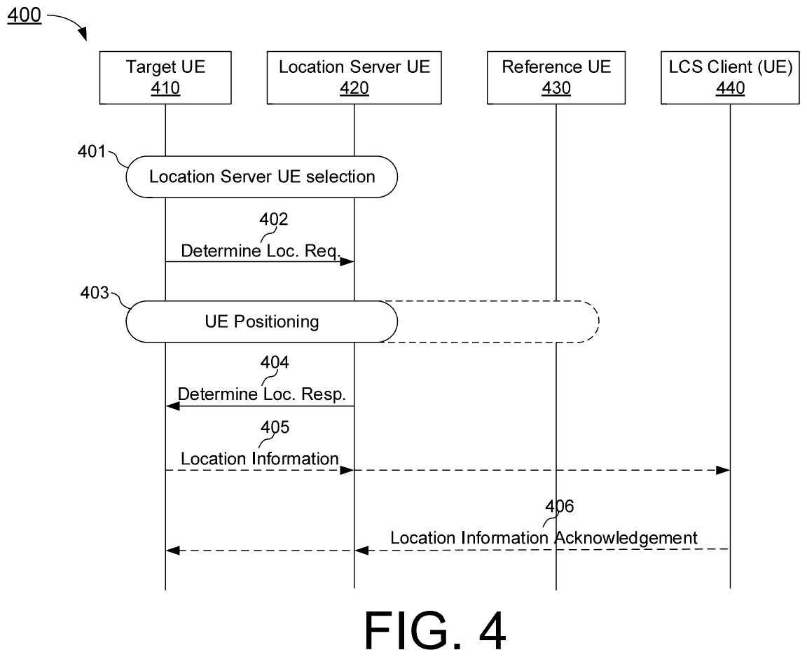

FIG. 4 illustrates an example scenario 400 under schemes in accordance with implementations of the present disclosure. Scenario 400 involves a target UE 410, a location server UE 420 (with GMLC/UDM-like functionality), a reference UE 430, and an LCS client 440. Scenario 400 illustrates an exemplary message sequence chart of a Case-II signaling framework for a PC5 MO LR procedure. In step 401, the target UE 410 determines whether it requires support from one location server UE, and if so, the target UE 410 selects a location server UE. Otherwise, if the target UE 410 determines that it does not need support from one location server UE, the procedure proceeds to step 403. The selection of a location server UE may be performed using direct discovery by both the target UE 410 and the location server UE 420. To facilitate direct discovery, either model A discovery or model B discovery may be used as follows (please refer to 3GPP TS 23.303 for definitions of models A and B discovery). With model A discovery, the location server UE 420 (or called an announcing UE) announces itself at least as a location server UE, and the target UE 410 (or called a monitoring UE) monitors such announcement. With model B discovery, the target UE 410 (or called a discoverer UE) issues requests including information that it wishes to discover a location server UE (or called a discoveree UE). Once a location server UE is selected, direct communication is established between the target UE 410 and the selected location server UE 420, allowing the procedure to proceed to step 402.

In step 402, the target UE 410 issues/transmits a Determine Location Request message to the selected location server UE 420, if the target UE 410 requires support from one location server UE. The Determine Location Request message contains necessary information as required by the intended location operation. Otherwise, if the target UE 410 does not require support from one location server UE, this step may be skipped.

In step 403, the UE positioning (and/or ranging) is performed by the target UE 410 alone or with support of the selected location server UE 420, depending on the outcome of step 401, in order to determine the location of the target UE 410. It is noteworthy that, if necessary, a reference UE 430 (or more reference UEs) may also be invoked at this point to assist the target UE 410 or the location server UE 420 in determining the location of the target UE 410.

In step 404, if a Determine Location Request message is received earlier, the location server UE 220 replies to the target UE 410 with a Determine Location Response message. The Determine Location Response message contains information indicating the calculated location of the target UE 410.

In step 405, if reporting to an LCS client is necessary as required by the intended location operation, the target UE 410 reports its location information to the location server UE 420, with necessary information allowing identification of the LCS client 340. The target UE 410 includes its SLPP information, which, together with the LCS client data allows the location server UE 420 to determine whether the LCS client 440 is authorized. If so, the location server UE 420 forwards the location information of the target UE 410 to the authorized LCS client 440. If reporting to an LCS client is not necessary, this step may be skipped.

In step 406, the LCS client 440 replies with an acknowledgement of receipt of the location information from the location server UE 420 which in turn forwards the acknowledgement to the target UE 410.

### Illustrative Implementations

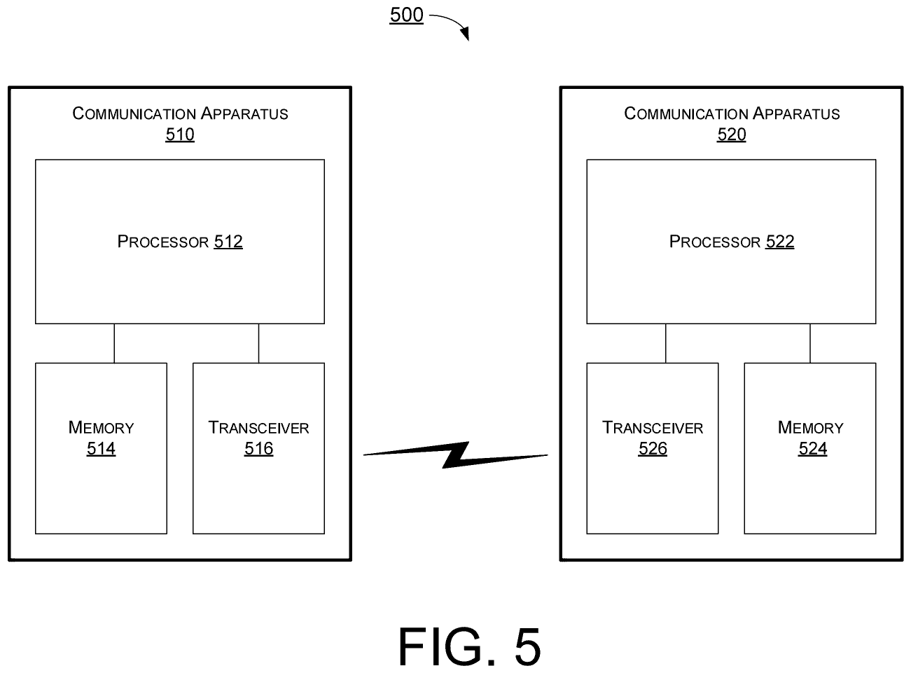

FIG. 5 illustrates an example communication system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to sidelink positioning in mobile communications, including scenarios/schemes described above as well as processes 600 and 700 described below.

Each of apparatus 510 and apparatus 520 may be a part of an electronic apparatus, which may be a UE (e.g., a UE operating as a target UE or a location server UE), such as a portable or mobile apparatus, a wearable apparatus, a vehicular device or a vehicle, a wireless communication apparatus or a computing apparatus. For instance, each of apparatus 510 and apparatus 520 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 510 and apparatus 520 may be implemented in a smart thermostat, a smart fridge, a smart door lock, a wireless speaker or a home control center.

In some implementations, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 510 and apparatus 520 may be implemented in or as a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to sidelink positioning in mobile communications in accordance with various implementations of the present disclosure.

In some implementations, apparatus 510 may also include a transceiver 516 coupled to processor 512. Transceiver 516 may be capable of wirelessly transmitting and receiving data. In some implementations, transceiver 516 may be capable of wirelessly communicating with different types of UEs/wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, apparatus 510 may further include a memory 514 coupled to processor 512 and capable of being accessed by processor 512 and storing data (e.g., target UE's SLPP information) therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 514 and memory 524 may include a universal integrated circuit card (UICC).

Each of apparatus 510 and apparatus 520 may be a communication entity capable of communicating with each other using various proposed schemes in accordance with the present disclosure. For illustrative purposes and without limitation, a description of capabilities of apparatus 510, as a target UE (e.g., target UE 110/210/310/410), and apparatus 520, as a location server UE (e.g., location server UE 120/220/320/420), is provided below.

Under certain proposed schemes in accordance with the present disclosure with respect to sidelink positioning in mobile communications, processor 512 of apparatus 510, implemented in or as a target UE, may determine whether the target UE requires support from one location server UE during a sidelink LR procedure. Additionally, processor 512 may select, via transceiver 516, a location server UE in a case that the target UE requires support from one location server UE. Furthermore, processor 512 may perform, via transceiver 516, UE positioning to determine a location of the target UE with or without support of the selected location server UE.

In some implementations, processor 512 may also transmit, via transceiver 516, to the selected location server UE a first request for determining the location of the target UE in a case that the target UE requires support from one location server UE. The UE positioning may be performed in response to the first request. Additionally, processor 512 may receive, via transceiver 516, from the selected location server UE a first response including information indicating the location of the target UE.

In some implementations, the sidelink LR procedure is initiated by an LCS client, and processor 512 may also receive, via transceiver 516, from the LCS client a second request for the location of the target UE, and determine whether the LCS client and the second request are authorized. The location server UE selection may be performed in a case that the LCS client and the second request are authorized. Additionally, processor 512 may transmit, via transceiver 516, to the LCS client a second response including information indicating the location of the target UE.

In some implementations, the second request may include LCS client data comprising at least one of an identify of the LCS client, a type of location request, and an accuracy of the location of the target UE.

In some implementations, the determination of whether the LCS client and the second request are authorized may be performed based on the LCS client data in the second request and SLPP information of the target UE.

In some implementations, the sidelink LR procedure is initiated by the target UE, and processor 512 may also transmit, via transceiver 516, to an authorized LCS client a report including information indicating the location of the target UE. Additionally, processor 512 may receive, via transceiver 516, from the authorized LCS client an acknowledgement of receipt of the report.

In some implementations, the location server UE selection may be performed using direct discovery comprising one of the following: receiving, via transceiver 516, from the selected location server UE an announcement that it serves as a location server UE; and transmitting, via transceiver 516, to the selected location server UE a third request for discovering a location server UE.

In some implementations, the UE positioning may include invoking one or more reference UEs to assist the target UE or the selected location server UE in determining the location of the target UE.

Under other proposed schemes in accordance with the present disclosure with respect to sidelink positioning in mobile communications, processor 522 of apparatus 520, implemented in or as a location server UE, may perform, via transceiver 526, a location server UE selection with a target UE or an LCS client during a sidelink LR procedure. Additionally, processor 522 may perform, via transceiver 526, UE positioning to determine a location of the target UE in a case that the target UE requires support from one location server UE.

In some implementations, processor 522 may also receive, via transceiver 526, from the target UE a first request for determining the location of the target UE in a case that the target UE requires support from one location server UE. The UE positioning may be performed in response to the first request. Additionally, processor 522 may transmit, via transceiver 526, to the target UE a first response including information indicating the location of the target UE.

In some implementations, the sidelink LR procedure is initiated by the LCS client, and processor 522 may also receive, via transceiver 526, from the LCS client a second request for the location of the target UE, and determine whether the LCS client and the second request are authorized. Additionally, processor 522 may forward, via transceiver 526, the second request to the target UE in a case that the LCS client and the second request are authorized. Moreover, processor 522 may receive, via transceiver 526, from the target UE a second response including information indicating the location of the target UE. Processor 522 may forward, via transceiver 526, the second response to the LCS client.

In some implementations, the sidelink LR procedure is initiated by the LCS client, and processor 522 may also transmit, via transceiver 526, to the target UE a third request for SLPP information of the target UE, in response to the second request. Additionally, processor 522 may receive, via transceiver 526, from the target UE a third response including the SLPP information of the target UE. The determination of whether the LCS client and the second request are authorized may be performed based on LCS client data in the second request and the SLPP information of the target UE.

In some implementations, the sidelink LR procedure is initiated by the target UE, and processor 522 may also forward, via transceiver 526, a report received from the target UE to the LCS client. The report may include information indicating the location of the target UE. Additionally, processor 522 may forward, via transceiver 526, an acknowledgement received from the LCS client to the target UE. The acknowledgement acknowledges receipt of the report.

### Illustrative Processes

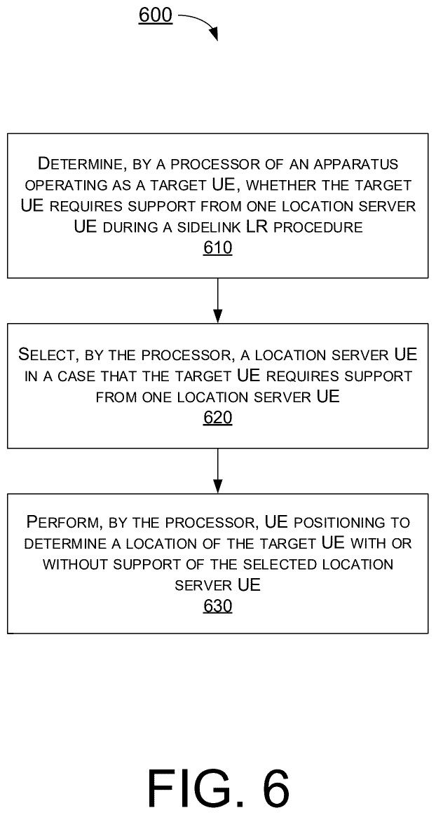

FIG. 6 illustrates an example process 600 in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to sidelink positioning in mobile communications, and, more particularly, to Case-I PC5 MT/MO LR procedure. Process 600 may include one or more operations, actions, or functions as illustrated by one or more of blocks 610, 620, and 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 510 and apparatus 520 as well as any variations thereof. Solely for illustrative purposes and without limiting the scope, process 600 is described below in the context of apparatus 510 as a target UE with GMLC-like functionality (e.g., target UE 110/210) and apparatus 520 as a location server UE (e.g., location server UE 120/220). Process 600 may begin at block 610.

At 610, process 600 may involve processor 512 of apparatus 510, implemented in or as a target UE, determining whether the target UE requires support from one location server UE during a sidelink LR procedure. Process 600 may proceed from 610 to 620.

At 620, process 600 may involve processor 512 selecting, via transceiver 516, a location server UE (e.g., apparatus 520) in a case that the target UE requires support from one location server UE. Process 600 may proceed from 620 to 630.

At 630, process 600 may involve processor 512 performing, via transceiver 516, UE positioning to determine a location of the target UE with or without support of the selected location server UE.

In some implementations, process 600 may further involve processor 512 transmitting, via transceiver 516, to the selected location server UE a first request for determining the location of the target UE in a case that the target UE requires support from one location server UE. The UE positioning may be performed in response to the first request. Additionally, process 600 may involve processor 512 receiving, via transceiver 516, from the selected location server UE a first response including information indicating the location of the target UE.

In some implementations, the sidelink LR procedure is initiated by an LCS client, and process 600 may further involve processor 512 receiving, via transceiver 516, from the LCS client a second request for the location of the target UE, and determining whether the LCS client and the second request are authorized. The location server UE selection may be performed in a case that the LCS client and the second request are authorized. Additionally, process 600 may involve processor 512 transmitting, via transceiver 516, to the LCS client a second response including information indicating the location of the target UE.

In some implementations, the second request may include LCS client data comprising at least one of an identify of the LCS client, a type of location request, and an accuracy of the location of the target UE.

In some implementations, the determination of whether the LCS client and the second request are authorized may be performed based on the LCS client data in the second request and SLPP information of the target UE.

In some implementations, the sidelink LR procedure is initiated by the target UE, and process 600 may further involve processor 512 transmitting, via transceiver 516, to an authorized LCS client a report including information indicating the location of the target UE. Additionally, process 600 may involve processor 512 receiving, via transceiver 516, from the authorized LCS client an acknowledgement of receipt of the report.

In some implementations, the location server UE selection may be performed using direct discovery comprising one of the following: receiving, via transceiver 516, from the selected location server UE an announcement that it serves as a location server UE; and transmitting, via transceiver 516, to the selected location server UE a third request for discovering a location server UE.

In some implementations, the UE positioning may include invoking one or more reference UEs to assist the target UE or the selected location server UE in determining the location of the target UE.

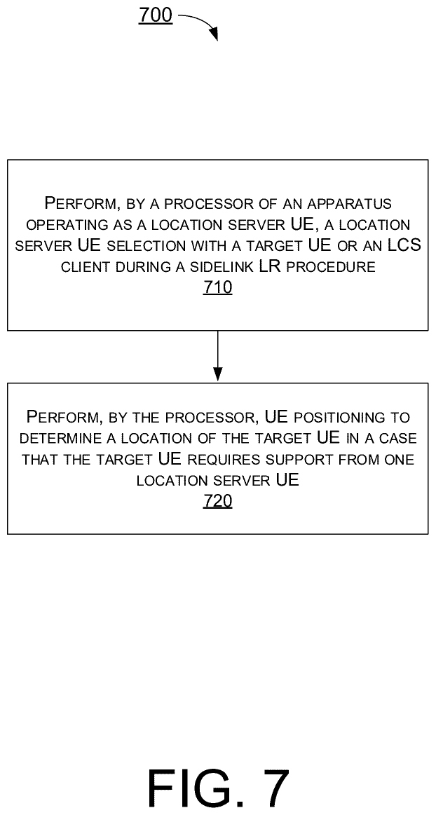

FIG. 7 illustrates an example process 700 in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to sidelink positioning in mobile communications, and, more particularly, to Case-II PC5 MT/MO LR procedure. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in apparatus 510 and apparatus 520 as well as any variations thereof. Solely for illustrative purposes and without limiting the scope, process 700 is described below in the context of apparatus 510 as a target UE (e.g., target UE 310/410) and apparatus 520 as a location server UE with GMLC/UDM-like functionality (e.g., location server UE 320/420). Process 700 may begin at block 710.

At 710, process 700 may involve processor 522 of apparatus 520, implemented in or as a target UE, performing a location server UE selection with a target UE (e.g., apparatus 510) or an LCS client during a sidelink LR procedure. Process 700 may proceed from 710 to 720.

At 720, process 700 may involve processor 522 performing, via transceiver 526, UE positioning to determine a location of the target UE in a case that the target UE requires support from one location server UE.

In some implementations, process 700 may further involve processor 522 receiving, via transceiver 526, from the target UE a first request for determining the location of the target UE in a case that the target UE requires support from one location server UE. The UE positioning may be performed in response to the first request. Additionally, process 700 may involve processor 522 transmitting, via transceiver 526, to the target UE a first response including information indicating the location of the target UE.

In some implementations, the sidelink LR procedure is initiated by the LCS client, and process 700 may further involve processor 522 receiving, via transceiver 526, from the LCS client a second request for the location of the target UE, and determine whether the LCS client and the second request are authorized. Additionally, process 700 may involve processor 522 forwarding, via transceiver 526, the second request to the target UE in a case that the LCS client and the second request are authorized. Moreover, process 700 may involve processor 522 receiving, via transceiver 526, from the target UE a second response including information indicating the location of the target UE. Process 700 may further involve processor 522 forwarding, via transceiver 526, the second response to the LCS client.

In some implementations, the sidelink LR procedure is initiated by the LCS client, and process 700 may further involve processor 522 transmitting, via transceiver 526, to the target UE a third request for SLPP information of the target UE, in response to the second request. Additionally, process 700 may involve processor 522 receiving, via transceiver 526, from the target UE a third response including the SLPP information of the target UE. The determination of whether the LCS client and the second request are authorized may be performed based on LCS client data in the second request and the SLPP information of the target UE.

In some implementations, the sidelink LR procedure is initiated by the target UE, and process 700 may further involve processor 522 forwarding, via transceiver 526, a report received from the target UE to the LCS client. The report may include information indicating the location of the target UE. Additionally, process 700 may involve processor 522 forwarding, via transceiver 526, an acknowledgement received from the LCS client to the target UE. The acknowledgement acknowledges receipt of the report.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus operating as a target user equipment (UE), whether the target UE requires support from one location server UE during a sidelink location request (LR) procedure;
selecting, by the processor, a location server UE in a case that the target UE requires support from one location server UE; and
performing, by the processor, UE positioning to determine a location of the target UE with or without support of the selected location server UE.

2. The method of claim 1, further comprising:
transmitting, by the processor, to the selected location server UE a first request for determining the location of the target UE in a case that the target UE requires support from one location server UE, wherein the UE positioning is performed in response to the first request; and
receiving, by the processor, from the selected location server UE a first response comprising information indicating the location of the target UE.

3. The method of claim 1, wherein the sidelink LR procedure is initiated by a location services (LCS) client, and the method further comprises:
receiving, by the processor, from the LCS client a second request for the location of the target UE;
determining, by the processor, whether the LCS client and the second request are authorized, wherein selecting the location server UE is performed in a case that the LCS client and the second request are authorized; and
transmitting, by the processor, to the LCS client a second response comprising information indicating the location of the target UE.

4. The method of claim 3, wherein the second request comprises LCS client data comprising at least one of an identify of the LCS client, a type of location request, and an accuracy of the location of the target UE.

5. The method of claim 4, wherein determining whether the LCS client and the second request are authorized is performed based on the LCS client data in the second request and subscriber LCS privacy profile (SLPP) information of the target UE.

6. The method of claim 1, wherein the sidelink LR procedure is initiated by the target UE, and the method further comprises:
transmitting, by the processor, to an authorized LCS client a report comprising information indicating the location of the target UE; and
receiving, by the processor, from the authorized LCS client an acknowledgement of receipt of the report.

7. The method of claim 1, wherein selecting the location server UE is performed using direct discovery comprising one of the following:
receiving, by the processor, from the selected location server UE an announcement that it serves as a location server UE; and
transmitting, by the processor, to the selected location server UE a third request for discovering a location server UE.

8. The method of claim 1, wherein the UE positioning comprises invoking one or more reference UEs to assist the target UE or the selected location server UE in determining the location of the target UE.

9. A method, comprising:
performing, by a processor of an apparatus operating as a location server user equipment (UE), a location server UE selection with a target UE or a location services (LCS) client during a sidelink location request (LR) procedure; and
performing, by the processor, UE positioning to determine a location of the target UE in a case that the target UE requires support from one location server UE.

10. The method of claim 9, further comprising:
receiving, by the processor, from the target UE a first request for determining the location of the target UE in a case that the target UE requires support from one location server UE, wherein the UE positioning is performed in response to the first request; and
transmitting, by the processor, to the target UE a first response comprising information indicating the location of the target UE.

11. The method of claim 9, wherein the sidelink LR procedure is initiated by the LCS client, and the method further comprises:
receiving, by the processor, from the LCS client a second request for the location of the target UE;
determining, by the processor, whether the LCS client and the second request are authorized;
forwarding, by the processor, the second request to the target UE in a case that the LCS client and the second request are authorized;
receiving, by the processor, from the target UE a second response comprising information indicating the location of the target UE; and
forwarding, by the processor, the second response to the LCS client.

12. The method of claim 11, wherein the sidelink LR procedure is initiated by the LCS client, and the method further comprises:
transmitting, by the processor, to the target UE a third request for subscriber LCS privacy profile (SLPP) information of the target UE, in response to the second request; and
receiving, by the processor, from the target UE a third response comprising the SLPP information of the target UE;
wherein determining whether the LCS client and the second request are authorized is performed based on LCS client data in the second request and the SLPP information of the target UE.

13. The method of claim 9, wherein the sidelink LR procedure is initiated by the target UE, and the method further comprises:
forwarding, by the processor, a report received from the target UE to the LCS client, wherein the report comprises information indicating the location of the target UE; and
forwarding, by the processor, an acknowledgement received from the LCS client to the target UE, wherein the acknowledgement acknowledges receipt of the report.

14. An apparatus, operating as a target user equipment (UE), the apparatus comprising:
a transceiver which, during operation, wirelessly communicates with one or more UEs; and
a processor communicatively coupled to the transceiver such that, during operation, the processor performs operations comprising:
determining whether the target UE requires support from one location server UE during a sidelink location request (LR) procedure;
selecting, via the transceiver, a location server UE in a case that the target UE requires support from one location server UE; and
performing, via the transceiver, UE positioning to determine a location of the target UE with or without support of the selected location server UE.

15. The apparatus of claim 14, wherein, during operation, the processor further performs operations comprising:
transmitting, via the transceiver, to the selected location server UE a first request for determining the location of the target UE in a case that the target UE requires support from one location server UE, wherein the UE positioning is performed in response to the first request; and
receiving, via the transceiver, from the selected location server UE a first response comprising information indicating the location of the target UE.

16. The apparatus of claim 14, wherein the sidelink LR procedure is initiated by a location services (LCS) client, and during operation, the processor further performs operations comprising:
receiving, via the transceiver, from the LCS client a second request for the location of the target UE;
determining whether the LCS client and the second request are authorized, wherein selecting the location server UE is performed in a case that the LCS client and the second request are authorized; and
transmitting, via the transceiver, to the LCS client a second response comprising information indicating the location of the target UE.

17. The apparatus of claim 16, wherein:
the second request comprises LCS client data comprising at least one of an identify of the LCS client, a type of location request, and an accuracy of the location of the target UE; and
determining whether the LCS client and the second request are authorized is performed based on the LCS client data in the second request and subscriber LCS privacy profile (SLPP) information of the target UE.

18. The apparatus of claim 14, wherein the sidelink LR procedure is initiated by the target UE, and during operation, the processor further performs operations comprising:
transmitting, via the transceiver, to an authorized LCS client a report comprising information indicating the location of the target UE; and
receiving, via the transceiver, from the authorized LCS client an acknowledgement of receipt of the report.

19. The apparatus of claim 14, wherein selecting the location server UE is performed using direct discovery comprising one of the following:
receiving, via the transceiver, from the selected location server UE an announcement that it serves as a location server UE; and
transmitting, via the transceiver, to the selected location server UE a third request for discovering a location server UE.

20. The apparatus of claim 14, wherein the UE positioning comprises invoking one or more reference UEs to assist the target UE or the selected location server UE in determining the location of the target UE.
